(19) United States
(12) Patent Application Publication
(10) Pub. No.: US 2025/0012308 A1
(43) Pub. Date: Jan. 9, 2025

(54) FITTING AND CONNECTOR FOR COMPONENTS

(71) Applicant: Knapp Holding GmbH, Euratsfeld (AT)

(72) Inventor: Friedrich KNAPP, Bad Kreuzen (AT)

(21) Appl. No.: 18/709,376

(22) PCT Filed: Nov. 15, 2022
(86) PCT No.: PCT/EP2022/081997

§ 371 Date: May 10, 2024

(30) Foreign Application Priority Data
Nov. 19, 2021 (EP) 21209269.6

(51) Int. Cl. F16B 12/20; F16B 12/26

(52) U.S. Cl. CPC F16B 12/20; F16B 12/26

(57) ABSTRACT

A fitting for a component, which has a groove with a groove base which is arcuately concave in the longitudinal direction of the groove and groove flanks which are in the form of circle segments, comprises a section with an end face which is arcuately convex in the longitudinal direction and two parallel lateral sides for insertion into the groove, wherein the end face is provided with at least one cutting rib arcuately extending in longitudinal direction.

### CROSS-REFERENCE TO RELATED APPLICATION/S

This application is a National Phase application of International Application No. PCT/EP2022/081997 filed Nov. 15, 2022 which claims priority to the European Patent Application No. 21 209 269.6 filed Nov. 19, 2021, the disclosures of which are incorporated herein by reference.

### TECHNICAL FIELD

The present disclosed subject matter relates to a fitting for a component, in particular a wooden component, which has a groove with a groove base which is arcuately concave in the longitudinal direction of the groove and groove flanks which are in the form of circle segments, which fitting has a section with an end face which is arcuately convex in the longitudinal direction and two parallel lateral sides for insertion into the groove. The disclosed subject matter also relates to a connector with two such fittings for connecting two components.

### BACKGROUND ART

Connectors of this kind are known for example from DE 10 2014 101 158 A1. These connectors are provided for components with grooves with arcuate undercuts, for which the respective fitting has non-self-tapping arcuate ribs for engaging with the undercuts. For anchoring the fitting to the associated component, the fitting is pushed into the groove from its end in an arcuate movement and is then secured by the undercuts against being pulled out of the component transversely to the groove.

One disadvantage of the known connectors is that the fitting can move in the groove in the longitudinal direction of the groove, which in the worst case can cause the components to fall apart. In DE 10 2014 101 158 A1 it was therefore proposed to provide an additional bore in the respective component that traverses the groove and can be used to accommodate an eccentric or a drive shaft for a locking hook that can hook into the opposite fitting in order to clamp the fittings against one another other. At the same time, the eccentric inserted into the bore of the component prevents the fitting from sliding out in the longitudinal direction of the groove. However, this structure is mechanically complex and not very suitable for use as a lowcost mass-produced article.

### BRIEF SUMMARY

The objective of the disclosed subject matter is to overcome the disadvantages of the aforementioned prior art and to create a fitting or connector which provides a durable and secure connection between the components in a cost-effective, simple and safe manner.

This objective is achieved in a first aspect of the disclosed subject matter by a fitting of the aforementioned kind, which is characterized in that the end face is provided with at least one cutting rib arcuately extending in longitudinal direction. The cutting rib of the disclosed subject matter on the end face (outer circumferential side) of the insertion section cuts into the groove base when the fitting is inserted into the groove, for example when it is hammered in with a hammer, and thus secures the fitting against sliding in the longitudinal direction of the groove by frictional engagement.

Optionally, the cutting rib has a triangular cross-section and, when viewed in longitudinal direction, is beveled at its ends with respect to the end face. This makes it particularly easy to drive the cutting rib into the groove base, in particular when driving in the fitting in an arcuate movement.

It is particularly advantageous, if the cutting rib is shorter than the end face when viewed in longitudinal direction and is positioned centrally on the end face, which makes it easier to insert the fitting into the groove at the start of the arcuate driving movement.

In a first optional variant, the cutting rib lies is positioned centrally on the end face when viewed transversely to the longitudinal direction. In a second optional variant, the end face can be provided with two parallel cutting ribs which are symmetrically off-center when viewed transversely to the longitudinal direction. Both variants result in a symmetrical distribution of force in the groove.

The cutting rib(s) of the disclosed subject matter on the end face of the fittings is/are particularly advantageous in combination with arcuate lateral cutting edges, as known from DE 196 04 243 C2 with the same inventor, i.e. when each lateral side is provided with at least one laterally projecting cutting edge which is arcuate in a manner concentric to the end face. The cutting edges secure the fitting in the groove against being pulled out transversely to the longitudinal direction of the groove, and the cutting rib(s) extending on the end face secure(s) the fitting against sliding in the longitudinal direction of the groove.

It is particularly advantageous if the cutting edges each have a cross-section in the form of a sawtooth, the sawtooth side of which facing away from the end face is normal to the respective lateral side. The said normal sawtooth sides thus form a good support surface against the fitting being pulled out transversely to the longitudinal direction of the groove.

Furthermore, this embodiment is also suitable for inserting the fitting into a groove, the groove flanks of which are each undercut close to the groove base. The sawtooth side of a cutting edge, which is normal to the respective lateral side of the fitting, thus forms a particularly good contact surface for the inner shoulder of the groove flank formed by the undercut, and the sawtooth tip cuts into the base of the undercut.

In an alternative optional configuration of the cutting edges for inserting into an undercut groove the cutting edges each have a cross-section in the form of a rectangle with a laterally attached triangle. The rectangular part of the cutting edge engages in the undercut of the groove flank, while the more protruding triangular part of the cutting edge attached thereto cuts into the base of the undercut.

In all embodiments with cutting edges for lateral arcuate cutting into an undercut or non-undercut groove, the cutting rib extending along the face of the fitting causes additional tensioning of the lateral cutting edges with respect to the groove flanks or their optional undercuts.

According to a further optional embodiment of the disclosed subject matter, the fitting is provided on its side facing away from the said section with at least one projecting tab for inserting into a pocket of another fitting. Alternatively, the fitting is provided on its side facing away from the said section with at least one slot-like pocket for sliding in reception of a projecting tab of another fitting. In this way, two fittings can be secured against mutual sliding in the longitudinal direction of the groove by interlocking the tabs and pockets.

In a further optional embodiment of the disclosed subject matter the fitting is provided on its side facing away from the said section with latching means for latching to a complementary other fitting. The latching means can in particular be resilient latching hooks for engaging in an undercut recess of the other fitting or an undercut recess for the engagement of resilient latching hooks of the other fitting. In this way, two fittings can be latched together detachably (or also permanently) in order to connect two components to one another.

In the embodiment with an undercut recess for the engagement of resilient latching hooks, a web for insertion between the two latching hooks of the other fitting can optionally be provided in the recess. In this way, in the assembled position of the fittings, in which the latching hooks of one fitting engage in the undercut recess of the other fitting, any unintentional sliding of the latching hooks out of the undercuts of the recess is made more difficult or largely prevented.

In a second aspect, the disclosed subject matter creates a connector comprising two fittings of the type presented here, which are configured to be screwed, hooked or latched together in order to connect two components to one another. A corresponding complementary configuration of the two fittings, in particular on the sides facing away from their insertion sections into the component grooves, can be achieved for example as in the documents DE 196 04 243 C2 or DE 10 2014 101 158 A1.

### BRIEF DESCRIPTION OF THE DRAWINGS/FIGURES

The disclosed subject matter is explained in more detail below with reference to the embodiments shown in the accompanying drawings. In the drawings:

FIG. 1 shows a connector of the disclosed subject matter, which is composed of two fittings according to the disclosed subject matter, each in a different embodiment, in a perspective view in the unconnected state;

FIG. 2 shows an example of a component with groove for receiving a fitting according to the disclosed subject matter in a perspective view:

FIG. 3 shows a section of a cross-sectional view of two components connected by the connector of FIG. 1; and

FIG. 4 shows a further embodiment of the connector of the disclosed subject matter in a side view in the connected state.

### DETAILED DESCRIPTION

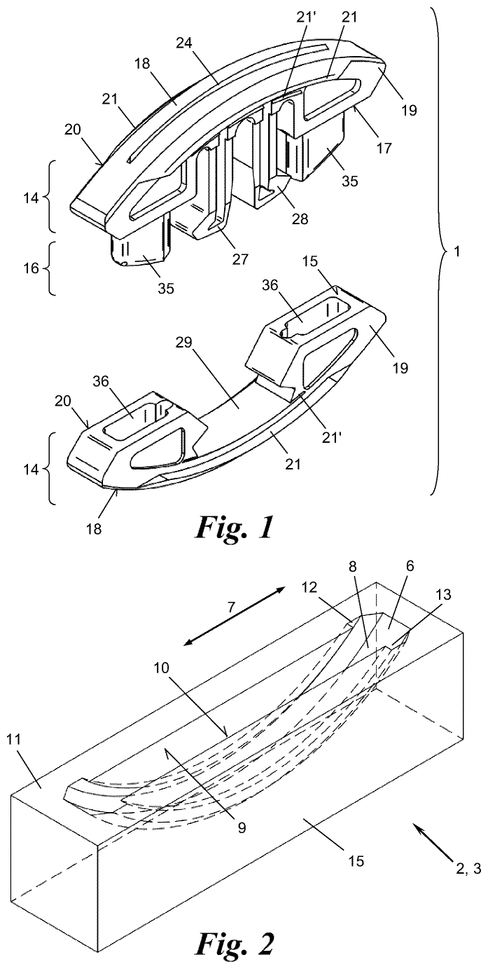

FIGS. 1, 3 and 4 show a connector 1 for connecting two components 2, 3 (see FIG. 2, 3). The components 2, 3 can be any type of component made of any material, such as wood, metal, plastic or the like. The connector 1 is specifically intended for connecting wooden components 2, 3, for example in furniture construction or industrial timber construction. Depending on the strength requirements, the connector 1 can be made of any material, for example wood, plastic, metal or combinations thereof. Particularly for small-format connectors 1 in furniture construction, the connector 1 can be made entirely of plastic, for higher strength requirements, e.g. for load-bearing structures in industrial timber construction, the connector can be made entirely of metal.

The connector 1 consists essentially of a first fitting 4 and a second fitting 5. The first fitting 4 is anchored to the first component 2 and the second fitting 5 is anchored to the second component 3. By connecting the two fittings 4, 5 together, e.g. by screwing, hooking or latching them together, as described in more detail below; the components 2, 3 are connected to one another securely-either permanently or detachably.

For anchoring the first fitting 4, the first component 2 has a groove 6 with a groove base 8 which is arcuately concave in longitudinal direction 7 of the groove 6 and groove flanks 9, 10 which are in the form of circle segments on both sides, see FIG. 2. The groove 7 extends on the top side 11 of the component 2 in the longitudinal direction of the groove 7 and has its greatest depth measured from the top side 11 of the component 2 to the groove base 8 in its center. The groove 6 optionally has an arcuate undercut 12, 13 on at least one of its groove flanks 9, 10, optionally on both groove flanks 9, 10.

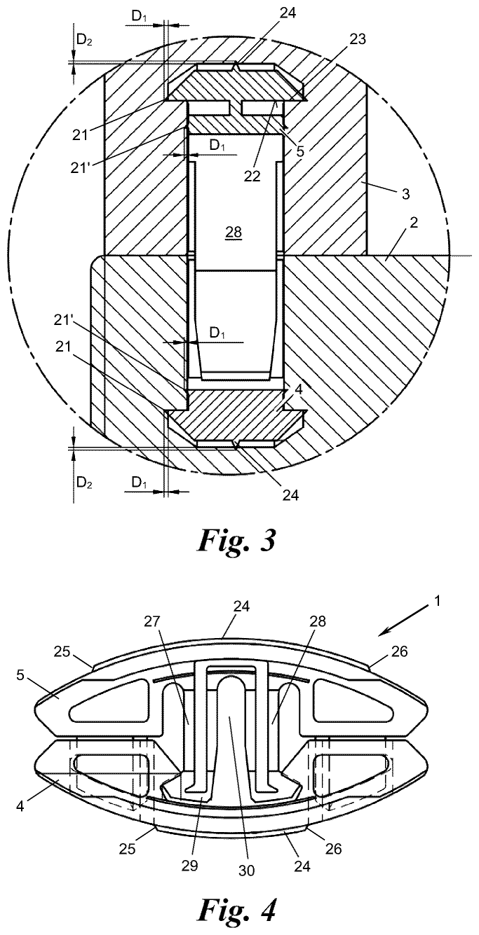

Essentially the same structure can be used to anchor the second fitting 5 to the second component 3, i.e. the second component 3 (FIG. 3) is provided with a similar groove 6, optionally with arcuate undercuts 12, 13. However, one of the fittings 4, 5 can also be a component itself, e.g. a coat hook, paneling part, lighting fixture, support part, etc.

Each of the fittings 4, 5 has a respective section 14 for anchoring in the respective groove 6. In the embodiment of the first fitting 4 shown in FIG. 1 the section 14 occupies the entire fitting 4, i.e. in the position anchored in the component 2, the fitting 4 is fully inserted into the groove 6 and the top side 15 is flush with the top side 11 of the component 2. In the embodiment of the second fitting 5 shown in FIG. 1, the section 14 of the fitting 5 inserted into the groove 7 occupies only part of the fitting 5, its other part 16 protrudes from a contact surface 17 of the section 14 inserted into the groove 7 which is flush with the top side 11 of the component 3 when the fitting 5 is anchored in the component 3. The part 16 of the fitting 5 projecting from the insertion section 14 is used to engage in the other fitting 4 in order to connect the fittings 4, 5 to one another, for example to screw, hook or latch them together, as will be described in more detail below:

For engagement in the respective groove 6, the section 14 of each fitting 4, 5 has an end face 18 which is arcuately convex in longitudinal direction 7 of the groove 6, the curvature of which is complementary to the curvature of the groove base 8, and two parallel lateral sides 19, 20, which come into contact with the groove flanks 9, 10.

On its lateral sides 19, 20 each fitting 4, 5 has a laterally projecting cutting edge 21 concentric to the arcuate shape of its end face 18. By means of the cutting edges 21, the fitting 4, 5 can be pushed into the respective groove 6 from one end thereof in an arcuate movement, the cutting edges 21 engaging both in the undercuts 12, 13 and with their tips into the bases of the undercuts 12, 13, i.e. the material of the respective component 2, 3, see the penetration or cutting depth D₁ of the cutting edges 21 into the components 2, 3 in FIG. 3.

In the example shown in FIG. 3, each cutting edge 21 has a cross-section in the form of a sawtooth, the sawtooth side 22 of which facing away from the end face 18 is normal to the respective lateral side 19, 20. As a result, the sawtooth side 22 forms a support surface for contacting the inner shoulder 23 of the groove 6 which is formed by the respective undercut 12, 13 and faces away from the groove base. This embodiment of the cutting edges 21 is thus particularly suitable for cooperating with a groove 6 with undercuts 12, 13. At the same time however, this embodiment of the cutting edge 21 is also suitable for non-undercut grooves 6 when the cutting edges 21 protrude less and their entire sawtooth portion protruding from the lateral sides 19, 20 is used for cutting into the groove flanks 9, 10.

Particularly in the case of undercut grooves 6, the cutting edges 21 can also have a cross-section different than the aforementioned sawtooth cross-section, for example a cross-section in the form of a rectangle with a laterally attached triangle. The rectangular portion of the cross-section then forms a rib with the contact surface 22, which can be inserted into the undercut 12. 13, and the laterally attached triangle of the cross-section then forms the edge of the cutting edge 21, which cuts into the base of the undercut 12, 13 with the penetration depth D1.

If desired, the lateral sides 19, 20 of the fittings 4, 5 can also be provided with further arcuate cutting edges 21′ concentric to the cutting edges 21 for cutting into the groove flanks 9, 10.

On the end face 18, each fitting 4, 5 is provided with (at least) one cutting rib 24 extending in the longitudinal direction of the groove 7 and following the arcuate shape of the end face 18. The cutting rib 24 has for example a triangular cross-section, but could also have any other cross-section forming a “knife edge”. At its two ends 25, 26 viewed in the longitudinal direction 7, the cutting rib 24 can be beveled with respect to the end face 18 (FIG. 4).

The cutting ribs 24 can extend over the whole length of the respective end face 18 or, as shown, can be shorter than the respective end face 18 when viewed in longitudinal direction 7 and then lie in particular in the center of the end face 18. In the example shown in FIG. 4, the cutting rib 24 of the first fitting 4 extends centrally over approximately a third of the entire length of the end face 18, whereas the cutting rib 24 of the second fitting 5 extends over approximately two thirds of the entire length of the end face 18. It is also possible to provide more than one cutting rib 24 on the end face 18, for example two parallel cutting ribs 24 lying symmetrically off-center when viewed transversely to the longitudinal direction 7, e.g. one cutting rib 24 near to each of the longitudinal edges of the end face 18.

On introducing the section 14 of the respective fitting 4, 5 into the groove 6 the cutting rib 24 penetrates into the material of the respective component 2, 3, see penetration depth D₂ in FIG. 3. The insertion of the respective fitting 4, 5 into the groove 6 can be assisted e.g. by hammer blows in order to drive the cutting ribs 24—and also the cutting edges 21, if provided—into the material of the components 2, 3. The beveled edges at the ends 25, 26 of the cutting rib 24 facilitate the driving in: similar beveled edges can also be provided on the cutting edges 21.

The cutting ribs 24—as well as the cutting edges 21, if provided-secure the fitting 4, 5 in the anchoring position in the groove 6 against sliding in the longitudinal direction of the groove 7 by means of frictional engagement. Furthermore, in the case of a groove 6 with undercuts 12, 13, the cutting ribs 24 also provide additional tensioning of the contact surfaces 22 of the cutting edges 21 against the inner shoulders 23 of the undercuts 12, 13, as can be seen from FIG. 3. The cutting ribs 24 also eliminate any play, by varying the penetration depth D₂ according to the available installation space in the groove 6.

Even with non-undercut grooves 6 when cutting edges 21 are used, the cutting ribs 24 support their tensioning in the grooves cut thereby into the material of the components 2, 3.

After the fittings 4, 5 have been anchored to the components 2, 3 by inserting their sections 14 into the grooves 6, the two fittings 4, 5 can be detachably or non-detachably joined to one another in any manner known in the prior art. For example, the fittings 4, 5 can be screwed together, e.g. if corresponding access holes are drilled through the components 2, 3 for screw connections between the fittings 4, 5. Alternatively or additionally, the fittings 4, 5 can be fixed to one another by latching hooks, sliding guides, bayonet locks etc., e.g. also only transversely to the longitudinal direction 7, in order to prevent the components 2, 3 from lifting away from one another.

In the embodiment shown in FIGS. 1, 2 and 4, for connecting the fittings 4, 5 each fitting 4, 5 is provided on its side 15 or 17 facing away from the insertion section 14 with latching means for latching with complementary latching means of the other respective fitting. In the example shown, the latching means are resilient latching hooks 27, 28 on the fitting 5, which engage in an undercut recess 29 of the other fitting 4. Optionally, a web 30 (FIG. 4) in the recess 29, which engages between the engaging latching hooks 27, 28, can block the latching hooks 27, 28 in the connected position (FIG. 4) against any unintentional springing out of the undercuts of the recess 29.

Of course, it is also possible for any other configuration of latching hooks, snap-in hooks, spring elements etc. to be used for the mutual interlocking of the fittings 4, 5.

In addition, the fittings 4, 5 can also be provided with sliding guides to facilitate the connection normal to the longitudinal direction 7. In the example shown, one fitting 5 is provided with one or more projecting tabs 35 on its side 17 facing away from the section 14, which can slide into complementary, slot-like pockets 36 on the other fitting 4. This guides the fittings 4, 5 in a direction perpendicular to the top sides of the component 11 on connection and ensures the correct latching of the latching means, here the latching hooks 27, 28 in the recess 29.

The disclosed subject matter is not limited to the embodiments shown, but includes all variants, modifications and combinations thereof which fall within the scope of the accompanying claims.

1. A fitting for a component, in particular a wooden component, which has a groove with a groove base which is arcuately concave in a longitudinal direction of the groove and groove flanks which are in a form of circle segments, which fitting has a section with an end face which is arcuately convex in longitudinal direction and two parallel lateral sides for insertion into the groove, wherein the end face is provided with at least one cutting rib arcuately extending in longitudinal direction.

2. The fitting according to claim 1, wherein the cutting rib has a triangular cross-section and, when viewed in longitudinal direction, is beveled at ends of the cutting rib with respect to the end face.

3. The fitting according to claim 1, wherein the cutting rib, when viewed in longitudinal direction, is shorter than the end face and is positioned centrally on the end face.

4. The fitting according to claim 1, wherein the cutting rib is positioned centrally on the end face when viewed transversely to the longitudinal direction.

5. The fitting according to claim 1, wherein the end face is provided with two parallel cutting ribs which are symmetrically off-center when viewed transversely to the longitudinal direction.

6. The fitting according to claim 1, wherein characterized in that each lateral side is provided with at least one, laterally projecting cutting edge which is arcuate in a manner concentric to the end face.

7. The fitting according to claim 6, wherein the cutting edges each have a cross-section in the form of a sawtooth, the sawtooth side of which facing away from the end face is normal to the respective lateral side.

8. The fitting according to claim 6 for inserting into a groove, the groove flanks of which are each undercut close to the groove base, wherein the cutting edges each have a cross-section in the form of a rectangle with a laterally attached triangle.

9. The fitting according to claim 1, wherein the fitting is provided on a side of the fitting facing away from said section with at least one projecting tab for insertion into a pocket of another fitting.

10. The fitting according to claim 1, wherein the fitting is provided on a side of the fitting facing away from said section with at least one slot-like pocket for sliding in reception of a projecting tab of another fitting.

11. The fitting according to claim 1, wherein the fitting is provided on a side of the fitting facing away from said section with latching means for latching to another fitting complementary thereto.

12. The fitting according to claim 11, wherein the latching means are resilient latching hooks for engaging in an undercut recess of the other fitting.

13. The fitting according to claim 11, wherein the latching means are an undercut recess for the engagement of resilient latching hooks of the other fitting.

14. The fitting according to claim 13, wherein a web is provided in the recess for insertion between two latching hooks of the other fitting.

15. A connector for two components, comprising two fittings according to claim 1, which are configured to be screwed, hooked or latched together.
